(19) United States
(12) Patent Application Publication
(10) Pub. No.: US 2012/0003953 A1
(43) Pub. Date: Jan. 5, 2012

(54) EMERGENCY CALL DEVICE

(76) Inventor: Walter Degelsegger, Desselbrunn (AT)

(21) Appl. No.: 13/148,585

(22) PCT Filed: Feb. 5, 2010
(86) PCT No.: PCT/AT10/00035

§ 371 Date: Aug. 9, 2011

(30) Foreign Application Priority Data
Feb. 9, 2009 (AT) A 211/2009
Mar. 3, 2009 (AT) A 346/2009

(51) Int. Cl. H04M 11/04

(52) U.S. Cl. 455/404.1

(57) ABSTRACT

An emergency call device which can be used to automatically detect and report criminal incidents. The device has a digital camera and/or a microphone having electronics interacting therewith for optically and/or acoustically recording events. An antenna having electronics interacting therewith for capturing dedicated geographic coordinates and establishing a radio connection to a remotely located station and for automatically transmitting information thereto, and an optical and/or acoustic signal device, which optically and/or acoustically highlights the function of the emergency call device at the site of the emergency call device, started by a simple push of a button. The emergency call device is part of a band to be worn on the body of a human. With an outer housing part and an inner housing part that can be telescoped therefrom.

The invention relates to an emergency call device.

A range of devices as well as methods and organization models relating to them have been proposed in the patent literature and are intended to be used as an aid for people who are being threatened or injured in a violent manner or have become uninvolved witnesses to criminal activities.

For this purpose, a small convenient device which can be operated easily is carried, which is able to record information from the location of the event, in the form of an image and/or audio and/or film, and which sends this information, as well as identification information relating to the user of this device, as well as information relating to the position of the event by radio to a remotely located station. This station then organizes assistance, such as a police action and if necessary a medical rescue action, and the received data is stored in a secure form in this station, allowing it to be used for legal action. Representative examples of devices and organization proposals such as these are described in the documents U.S. Pat. No. 4,884,132 A, EP 1277333 B1, DE 2910016 A1, EP 617869 B1, DE 10128728 C2, DE 19726357 A1, DE 19836118 A1, DE 29819117 U1, EP 875875 A2 and DE 102006001179 A1.

The individual proposals differ in terms of the nature, content and format of the data to be transmitted, in terms of the proposed transmission network, and in terms of precisely what is done after data transmission.

The majority of the proposals are based on the capability for rapid assistance in an emergency—not only in the case of attacks or the like, but also in the event of medical emergencies—and on the capability to store helpful reference information. However, until now, none of the devices and none of the organization forms associated with them have been implemented to a significant extent. One major disadvantage of all the previous cited proposals is that, with regard to criminal attacks, they relate only to subsequent actions, but scarcely at all to their avoidance.

The documents US 2003/0137422 A1, US 2007/0200716 A1, U.S. Pat. No. 6,876,302 B1, US 2008/0001764 A1, DE 10 2006 016 924 A1, US 2006/0201964 A1, DE 101 23 341 A1, DE 203 07 641 U1 and EP 1 953 721 A1 disclose emergency call devices of the type mentioned initially which additionally have a signaling device which acts at the location of the event. When an alarm is initiated, signaling is therefore also provided acoustically and/or optically at the location of the event that an emergency call device is present, that an alarm has been initiated, and that this information has been sent. In addition to the automatic documentation and signaling of criminal attacks (and other emergencies), these devices also help to an increased extent to in fact prevent criminal attacks in this case.

Another object on which the invention is based is to provide an emergency call device which carries out all the essential functions according to the cited prior art. A further aim is to allow it to be carried more conveniently, to allow it to respond optically, and nevertheless to have the simple and reliable initiation capability required for alarm situations, to have a greater protection against inadvertent initiation.

In order to achieve this object, it is proposed that an emergency call device be designed such that it can carry out the functions known from the prior art and, in addition, such that:
the emergency call device is part of a strap which can be worn on the body of a person,
such that the emergency call device has an outer housing part and an inner housing part, wherein the inner housing part can be surrounded by the outer housing part and can move between a more and a less surrounded position relative to the outer housing part, and
such that the emergency call device functions which are intended for an acute situation can be started only when the inner housing part is in the less surrounded position relative to the outer housing part.

In addition to the known functions, the invention provides for the emergency call device to be equipped with data recording and data transmission with a signaling function, by means of which it can easily be identified as an emergency call device, and by which means it is possible to identify that the device has been activated, and therefore that data recording and data transmission have been started.

A considerable proportion of potentially criminal people will avoid or break off an intended criminal action or a criminal action which they are carrying out if they realize that this action is being well documented and that the emergency services have already been informed.

The invention will be explained in more detail with reference to one exemplary embodiment, which is also illustrated by a drawing.

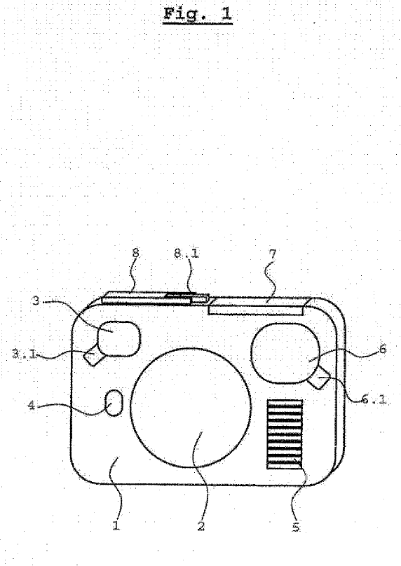

FIG. 1: shows an oblique outline view of a first exemplary emergency call device.

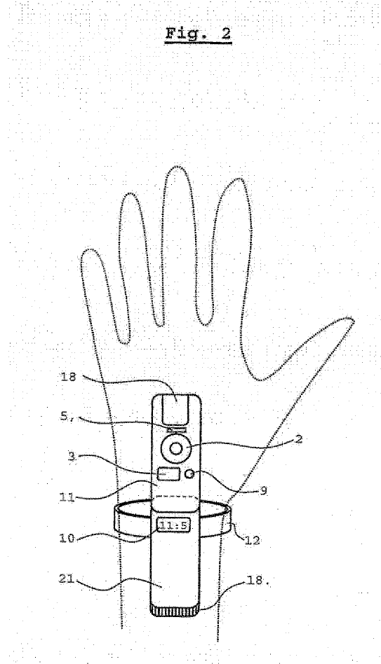

FIG. 2: shows a front view of a second exemplary emergency call device.

The housing 1 of the exemplary emergency call device according to the invention shown in FIG. 1 is approximately in the form of a flat prism, whose short edges are rounded. Its two larger surfaces can be somewhat larger than the area of a check card, for example 8 by 5 centimeters. The size of the housing at right angles to these surfaces, that is to say its depth, is typically about one centimeter, and perhaps also somewhat less than this. Other shapes are, of course, also possible in addition to the illustrated flat-prismatic shape. The illustrated shape has the advantage that it can be carried better in clothing or in a small pocket, than most other shapes, of the same volume.

In addition to the housing 1, the major important parts and functions of the emergency call device according to the invention are:

The digital camera 2 is used to record images, image sequences and/or films. It can be designed like a conventional digital camera. It is important that it is automatically focused. A long depth of focus is also very advantageous. The color reality of the recorded optical information is, for example, not necessarily as important.

An illumination device 3 provides the necessary illumination for the recordings made by the camera. For photographs, this illumination is a flash or a sequence of flashes, while this illumination is a long-term light for film recordings. One additional advantageous function of the illumination device is to emit an optical signal which signals at the location of the event that an emergency is occurring and/or that the device is active and the current event is being recorded and transmitted. The signaling function of the illumination can be switched by a key 3.1 which, in the illustrated example, is fitted in the area close to the illumination device 3.

The information relating to the range to an object is detected with the aid of optical sensors 4 in order to control the focusing device of the camera, and the environmental brightness is detected in order to appropriately control the illumination device.

A microphone 5 is used to record sounds from the surrounding area.

A loudspeaker 6 is in any case used to emit an acoustic signal at the location of the event, which signals that an emergency is occurring and/or that the device is active and the current event is being recorded and transmitted. This signaling function can be switched to be silent, by pushing a key 6.1. The required radio links are produced via an antenna 7. On the one hand, this is the link to the remotely located station, preferably produced via an existing mobile radio network, and on the other hand this is the required radio link to reference points such as, typically, satellites for GPS service, with the aid of which the geographic coordinates of the location at which the emergency call device is currently located are detected.

The functions intended for use, specifically data recording, setting up a link to a remotely located station and transmission of the data to the remotely located station and locally acting optical and/or acoustic signals can be initiated by pushing in the initiation button 8.

In order to prevent the initiation button 8 from being pressed accidently, it is advisable to provide a safety apparatus for this purpose, as in the case of hunting weapons, which should be switched to the “armed” state first of all before the initiation button 8 can be pressed. In the illustrated example, the safety apparatus is a slide 8.1 which is fitted to the initiation button or to the movement path of the initiation button 8 in the housing 1 and can be pushed to and fro between a position in which it blocks the mobility of the initiation button and a position in which it allows the initiation button to move. A mechanical safety apparatus, whose purpose and function can immediately be identified easily and clearly is preferable to an electronic safety apparatus, whose purpose and method of operation can be made identifiable only indirectly.

The drawing does not illustrate the electronics which are, of course, required and are contained in the emergency call device, and with the aid of which said functions and the functions which are also listed in the following text can be implemented in a manner known per se by a person skilled in the art.

Further supplementary functions and components, some of which are indispensable and some of which are optional, for an emergency call device according to the invention, but which are not symbolized by a visible feature in FIG. 1, are:
A battery, which is best rechargeable, is accommodated in the interior of the device. A second battery can be added to this, which is not rechargeable, but has a particularly long life and is particularly robust for this purpose (for example insensitive to cold). It is also essential to provide a display apparatus for the state of charge of the batteries, as well as a warning device which operates as soon as the state of charge tends toward the end.
A plug connection for the connection of the rechargeable battery to an external electrical power source.
A plug connection for a data line to an external computer, with the aid of which emergency call device settings can be edited using an appropriate program for this purpose.

The example of an emergency call device shown in FIG. 2 is part of an arm strap which can be worn on the wrist joint. It has an outer housing 21 and an inner housing 11, which can be folded out therefrom or can be pivoted out therefrom. The outer housing may be in the form of an attractive piece of jewelry, and it may include an electronic time indication 10, including all the other functions of a conventional wristwatch. Those parts and functions which are essential for the operation as an emergency call device—as already described above—can once again be accommodated on the inner housing 11.

If the emergency call device as shown in FIG. 2 is worn on the palm side of the lower arm, the inner housing 11 is moved out of the outer housing 21, which is arranged in the area of the wrist joint, toward the palm, and the initiation key is fitted to the palm-side end of the housing 11, then the initiation key 18 can be initiated by a fingertip of that hand on which the emergency call device is worn.

The operation of the initiation key 18 should advantageously be controlled such that the initiation key can become effective only when the inner housing 11 has been moved out of the outer housing 21. The key 18.1, by means of which the inner housing 11 is pushed or folded out of the outer housing 12, therefore also acts as a safety device against spurious initiations.

In addition to the functions which have already been described further above with respect to the exemplary embodiment shown in FIG. 1, the emergency call device shown in FIG. 2 also has focusing assistance 9. Once the initiation key has been pressed, this transmits a light beam parallel to that direction in which the image center of the image recorded by the camera 2 is located. The focusing assistance 9 can essentially be implemented, for example, by a laser diode with a low light power level, in the visible wave spectrum. The image center of the image recorded by the camera 2 is thus marked by the impact point of the light beam in the surrounding area. Since it should be expected that the person who is using the emergency call device may be very nervous when using it, this function can be very valuable.

A multiplicity of worthwhile proposals and variation options have already been mentioned in the documents relating to the prior art for the precise organization of what happens in the event of an emergency. Because of the multiplicity of organization options, it is advantageous to design the emergency call device such that it can be coupled to an external computer, thus making it possible to select conveniently between various possible settings on the external computer and thus to download personal data, without the emergency call device itself having to have a large number of keys and function menus for this purpose. Without any claim to completeness, the following examples of subjects are mentioned for such basic settings/personal data:
Who is the keeper of the device (name, gender, date of birth, address, identification information for medical insurance, etc.)
Via which communication network can the remotely located station be accessed; what is the address (telephone number) of the station?
Is or are there one or more substitute stations/substitute networks/substitute addresses if the above remotely located station or stations cannot be accessed?
Connection data for the substitute stations.
Apart from the remotely located station, should further addressees—for example parents—be notified by the device itself?
   What is sent to the additional addresses? (text message, position information, all recordings, etc.)
What should the remotely located station that has been accessed do? Options:
   What information should be sent to whom (prepared text, transmitted recorded data, etc.)?
   Which emergency service should be notified if appropriate (which police station, which rescue station)?
   What should be checked before initiating an alarm with the emergency service? Options:
      Nothing. Alarm is initiated immediately
      Assess transmitted data?
      Call person locally and produce an alarm only if there is no unambiguous all clear message in this case?
      Initiate alarm if no all clear message arrives within a specific period, which can be set in advance.
         How should the all clear message appear? Options:
            Code word sent by SMS
            Code word sent from a specific location by SMS
How should the emergency call device operate at the location in an acute situation? Options:
   Options for the method of operation of the locally acting signaling device:
      Start the signaling device immediately after pressing the initiation button:
      Start the signaling device only when a connection has been made to the remote station and the first data packet has been transmitted?
      Signaling device starts to operate automatically and can be switched off by an additional button 3.1, 6.1
      Signaling device does not start to operate automatically, and can be switched on by an additional button 3.1, 6.1.
      What type of signals are produced? Options:
         Optical (various lights which, for example, can provide reminders to emergency services such as rescue, police, fire service)
         Acoustic
            various siren tones
            various text outputs formulation in various languages to explain that this situation has been documented and signaled and that emergency services have been alerted. supplementary requests or reminders to remain calm loud calls for help

In one advantageous organization form, the remotely located station calls the person who is the keeper of the emergency call device as one of the first steps after the arrival of an emergency call message sent by an emergency call device. If it is absolutely clear from the telephone call that the person is coping with the situation on his own, the emergency services or trusted persons are not alerted any further, otherwise they are. In addition, the details of the organization process associated with this—dialing of what telephone number locally, which services/people should be notified in any case/secret code words which either mean “danger, help needed irrespective of what I otherwise also say (there is a pistol pointed at me)” or “unambiguous all clear message” should best be programmed in the emergency call device by means of a computer coupled to the emergency call device.

As an alternative to storage of the settings in the emergency call device, it is, of course, also possible to store the settings in the remotely located station, for each uniquely identifiable emergency call device. However, the relevant emergency call device itself should be used, rather than, for example, a PC or the Internet, as the data transmission device to the station in order to signal the settings, since this makes it possible to provide better protection against manipulations by third parties.

In the situation in which the setting is for the remotely located station to locally call the person who is the keeper of the emergency call device (before initiating further alarms), the person should be dialed by telephone automatically in the remotely located station, in order that this dialing can be carried out quickly and without risk of incorrect dialing. It is advantageous to fit an additional key to the emergency call device, by means of which a test emergency call can be made—which can be identified by the remotely located station. This is intended to offer the capability, without any risk of expensive false alarms, of trying out the technical functions of all the components and, organizationally, to speak to the remotely located station.

Despite the numerous functions which can be selected in a versatile form and can be initiated from the emergency call device, the emergency call device according to the invention may itself be designed to be very simple, and such that it can be operated very easily. This is of critical importance since an emergency may occur for the first time months or years after purchase or after initial training with the emergency call device, that is to say at a time when the person who is the keeper of the device has already forgotten the more detailed knowledge. Furthermore, it should be remembered that, in an emergency, this person may be subject to considerable stress and, for this reason, may also not be able to correctly initiate the correct key on a relatively complicated device.

Dangerous situations can be made safer or can be avoided by means of the signals which originate from the location of the occurrence itself and are emitted by the emergency call device.

1. An emergency call device which can be used for the automatic documentation and signaling of criminal attacks, which
a. has a digital camera and/or a microphone having electronics which interact therewith and are used to record and store optical and/or acoustic information,
b. and an antenna and electronics which interact therewith in order in this way to allow the own position to be identified in conjunction with a satellite-based navigation system,
c. and an antenna and electronics which interact therewith in order to allow a radio link to be produced to a remotely located station and to allow automatically recorded information and information relating to the own geographic coordinates to be sent to this station,
d. wherein these means can be started simply by pushing a button on an initiation key,
e. wherein the emergency call device furthermore has an optical and/or an acoustic signaling device by means of which the operation of the emergency call device can be indicated audibly and/or visibly at the location where the emergency call device is located, wherein
f. the emergency call device is part of a strap which can be worn on the body of a person,
g. in that the emergency call device has an outer housing part and an inner housing part, wherein the inner housing part can be surrounded by the outer housing part and can move between a more and a less surrounded position relative to the outer housing part, and
h. wherein the emergency call device functions which are intended for an acute situation can be started only when the inner housing part is in the less surrounded position relative to the outer housing part.

2. The emergency call device as claimed in claim 1, wherein a time indication is fitted to the outer housing and can then also be seen when the inner housing is in the more surrounded position.

3. The emergency call device as claimed in claim 1, wherein the emergency call device is fitted to an arm strap, which can be fitted to the lower arm of a person, in the area of the wrist joint.

4. The emergency call device as claimed in claim 3, wherein, during the movement to the position less surrounded by the outer housing, an area of the inner housing is moved away from the plane of the arm strap, and in that the initiation key is fitted to that area of the inner housing which is furthest from the plane of the arm strap when the inner housing is in the less surrounded position.

5. The emergency call device as claimed in claim 2, wherein the emergency call device is fitted to an arm strap, which can be fitted to the lower arm of a person, in the area of the wrist joint.

6. The emergency call device as claimed in claim 5, wherein, during the movement to the position less surrounded by the outer housing, an area of the inner housingis moved away from the plane of the arm strap, and in that the initiation key is fitted to that area of the inner housing which is furthest from the plane of the arm strap when the inner housing is in the less surrounded position.
